(19) United States
(12) Patent Application Publication
(10) Pub. No.: US 2026/0148961 A1
(43) Pub. Date: May 28, 2026

(54) METHODS FOR THE CONTROLLED SYNTHESIS OF LAYERED LITHIUM AND SODIUM TRANSITION METAL OXIDES USING ELECTROCHEMICALLY ASSISTED ION-EXCHANGE

(71) Applicant: The University of Chicago, Chicago, IL (US)

(72) Inventors: Chong Liu, Chicago, IL (US); Yu Han, Chicago, IL (US)

(21) Appl. No.: 19/452,571

(22) Filed: Jan. 19, 2026

Related U.S. Application Data
(62) Division of application No. 18/176,857, filed on Mar. 1, 2023, now Pat. No. 12,555,767.
(60) Provisional application No. 63/315,698, filed on Mar. 2, 2022.

(51) Int. Cl. H01M 4/04; H01M 4/505; H01M 4/525; H01M 10/052

(52) U.S. Cl. CPC H01M 4/0459; H01M 4/505; H01M 4/525; H01M 10/052

(57) ABSTRACT

Methods for synthesizing layered lithium transition metal oxides from layered sodium transition metal oxides are provided. Also provided are electrodes for lithium-ion batteries that include the layered lithium transition metal oxides. Similarly, methods for the synthesis of layered sodium transition metal oxides from layered lithium transition metal oxides and electrodes for sodium-ion batteries that include the layered sodium transition metal oxides are provided. The methods couple electrochemical intercalation of alkali ions (Li⁺ or Na⁺) with ion-exchange to overcome the kinetic limitation of ion-exchange in the layered alkali transition metal oxides at low vacancy concentrations.

### CROSS REFERENCE TO RELATED APPLICATIONS

The present application is a divisional of U.S. patent application Ser. No. 18/176,857, filed Mar. 1, 2023, the entire contents of which are incorporated herein by reference, which claims priority to U.S. provisional patent application No. 63/315,698 that was filed Mar. 2, 2022, the entire contents of which are incorporated herein by reference.

### BACKGROUND

Ion-exchange has been used in the battery field to prepare cathode materials having meta-stable structures for lithium-ion and sodium-ion batteries. Ion exchange is a process, usually conducted under relatively mild temperature conditions, involving exchanging ions in a solid material with other ions in surrounding liquid components, solutions, or molten salts, in which the “backbone” framework of the solid materials will be crystallographically preserved. Ion exchange is a facile and dedicated soft-chemical process for the synthesis of materials that cannot be directly achieved by a direct synthesis route. Thus, ion exchange is widely used in the battery field to prepare novel cathode materials. O2—LiCoO₂, layered LiMnO₂, A—Li_{2/3}MO₂ (A=O2, T2, O6, M represents combinations of Li, Co, Mg, Mn, Ni, Ti), LiNi_{0.5}Mn_{0.5}O₂ with fewer Ni/Li exchanges, and alluaudite LiMPO₄ (M=Fe, Mn) are examples of materials that have been made using ion-exchange.

Synthesizing cathode materials via ion-exchange process is typically conducted using a trial-and-error approach. Usually, however, one cannot ascertain the chemical compositions of exchanged products without direct measurements, nor can one ascertain whether the parent phase still remains in the products. Moreover, previous ion-exchange studies usually exchanged the as-synthesized starting materials, such as Na_{2/3}MO₂, and NaMO₂ (M represents transition metal), in which the effect of vacancy on the ion-exchange process was neglected.

### SUMMARY

Methods for synthesizing layered lithium transition metal oxides from layered sodium transition metal oxides are provided. Also provided are electrodes for lithium-ion batteries that include the layered lithium transition metal oxides. Further provided are methods for the synthesis of layered sodium transition metal oxides from layered lithium transition metal oxides and electrodes for sodium-ion batteries that include the layered sodium transition metal oxides.

One embodiment of a method for synthesizing a layered oxide having the formula LiₓNa_{y}MO₂, where 0<x<1 and 0<y<1 and M is Co, Mn, or Ni, includes the steps of: (a) providing a layered cobalt metal oxide having the formula Na_{y}MO₂, where 0.57≤y≤0.67; (b) conducting a first cation-exchange on the Na_{y}MO₂, where 0.57≤y≤0.67, in a solution containing dissolved lithium ions to convert the Na_{y}MO₂, where 0.57≤y≤0.67, into a material comprising discrete phases of Li_{0.94}MO₂ and Na_{y}MO₂, where 0.45≤y≤0.51; (c) conducting an electrochemical intercalation of lithium ions into the material to increase the Li_{0.94}MO₂ fraction in the material and regenerate Na_{y}MO₂, where 0.57≤y≤0.67; and (d) conducting an additional cation-exchange on the material in the solution containing dissolved lithium ions material to increase the Li_{0.94}MO₂ fraction in the material and convert the Na_{y}MO₂, where 0.57≤y≤0.67, back into Na_{y}MO₂, where 0.45≤y≤0.51.

One embodiment of an electrode for a lithium ion battery comprises a material comprising discrete Li_{0.94}MO₂ and Na_{y}MO₂ phases, where 0.45≤y≤0.51, wherein the phase fraction of Li_{0.94}MO₂ in the material is at least 90 mol. %.

One embodiment of a method for synthesizing a layered oxide having the structure Na_{y}MO₂, where 0.45≤y≤0.51 and M is Co, Mn, or Ni, includes the steps of: (a) providing a layered cobalt metal oxide having the structure LiMO₂; (b) conducting an electrochemical deintercalation of lithium ions from the material to convert the LiMO₂ into Li_{0.4}MO₂; and (c) conducting a cation-exchange on the Li_{0.4}MO₂ in a solution containing dissolved sodium ions to convert the Li_{0.4}MO₂ into a material comprising Na_{y}MO₂ phases, where 0.45≤y≤0.51, wherein the phase fraction of Na_{y}MO₂ in the material is at least 0.98 mol. %.

One embodiment of electrode for a sodium ion battery comprises a material comprising Na_{y}MO₂ phases, where 0.45≤y≤0.51, wherein the phase fraction of Na_{y}MO₂ in the material is at least 0.98 mol. %.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings.

FIGS. 1A-lE show phase separation and two-phase equilibrium between Li_{0.94}CoO₂ and Na_{0.48}CoO₂. FIG. 1A shows galvanostatic curves of P3-Na_{y}CoO₂ in the range of 0.37<y<0.92 and LiₓCoO₂ in the range of 0.37<x<1.0 at C/80. FIG. 1B shows open-circuit voltage (OCV) curves of P3-Na_{y}CoO₂ (y=0.37, 0.47, 0.57, 0.67, 0.77, 0.87) during ion exchange. Inset: enlarged OCV curve of Na_{0.67}CoO₂ showing the “pseudo-charging” behavior with four characteristic plateaus. FIG. 1C shows synchrotron X-ray diffraction patterns of Na_{y}CoO₂ (y=0.37, 0.57, 0.67, 0.87) before and after 24 h ion exchange. Gray dash lines indicate the (003) peak positions of equilibrated phases Na_{0.48}CoO₂ (left) and Li_{0.94}CoO₂ (right). Na_{0.57}CoO₂ and Na_{0.67}CoO₂ which showed phase equilibrium behaviors are highlighted. FIG. 1D shows chemical compositions of LiₐNa_{b}CoO₂. Black dots and white dots are the Li contents and Na contents measured after 24 h and 15 d (labeled by the arrows) ion exchange, respectively, for Na_{y}CoO₂ (y=0.37, 0.47, 0.57, 0.67, 0.72, 0.77, 0.87). The dash lines are predicted Li and Na contents based on phase equilibrium. FIG. 1E shows Rietveld refinements of patterns in FIG. 1C: Na_{0.67}CoO₂ (top) after 24 h ion exchange with 39.7% Li_{0.94}CoO₂ and 60.3% Na_{0.48}CoO₂ and Na_{0.57}CoO₂ (bottom) after 24 h ion exchange with 17.9% Li_{0.94}CoO₂ and 82.1% Na_{0.48}CoO₂.

FIGS. 2A-2F show revealing structural evolution during Li ion exchange with Na_{0.67}CoO₂. FIG. 2A shows a HAADF-STEM image, EDS maps, and Li EELS map of Na_{0.67}CoO₂ after reaching equilibrium. Na locates in the center and Li locates at the edges and corners of the particle. Scale bar, 30 nm. FIG. 2B shows synchrotron X-ray diffraction patterns of different intermediate states. Gray dash lines indicate the (003) peak positions of equilibrated phases Na_{0.48}CoO₂ (left) and Li_{0.94}CoO₂ (right). FIG. 2C shows Lithium contents (measured (dots) and calculated (line) based on evolution equation) as a function of Na phase during ion exchange. FIG. 2D shows OCV curves of Na_{0.67}CoO₂ ion exchanging in ACN solutions with different Li—Na ratios. The curve of 1 M Li is overlapping with the curve of 1-1 Li—Na. FIG. 2E shows in-situ synchrotron XRD patterns of the Na (003) peak and Li (003) peak during Na_{0.67}CoO₂ ion exchange in 1 M Li ACN solution. The nucleation and left-shift of the Li_{0.94}CoO₂ peak starting from ˜1000 s accompanied by Na (003) peak left-shift were clearly revealed. FIG. 2F is a schematic showing both the surface reaction-limited and diffusion-limited exchange pathways at low Li and high Li ratios, respectively. Na_{0.64} is one example Na phase of a surface reaction-limited ion exchange pathway.

FIGS. 3A-3E show reverse conversion from LiₓCoO₂ to Na_{y}CoO₂. FIG. 3A shows electrochemical curves of commercial LiCoO₂ after deintercalation of 40%, 50%, and 60% capacities in 1 M Na solution at C/10 with additional 41 h, 40 h and, 39 h soaking, respectively. FIGS. 3B, 3C show XRD patterns (FIG. 3B) and chemical compositions (FIG. 3C) of Li_{0.40}CoO₂, Li_{0.50}CoO₂, and Li_{0.60}CoO₂ after reaching equilibrium in 1 M Na solution. The dash lines are predicted Li and Na contents based on phase equilibrium. FIG. 3D shows an atomic resolution HAADF-STEM image of fully converted Na_{0.48}CoO₂ along [010] zone axis and the signal profile from the dashed area. Scale bar, 1 nm. FIG. 3E shows a SEM image and EDS maps of fully converted Na_{0.48}CoO₂. Scale bar, 30 m. FIG. 3F shows a HAADF-STEM image and EDS maps of fully converted Na_{0.48}CoO₂. Scale bar, 50 nm.

FIGS. 4A-4E show full conversion from Na_{y}CoO₂ to LiₓCoO₂ by electrochemical assisted ion exchange. FIG. 4A shows electrochemical curves of the electrochemical assisted ion exchange process. Once the intercalation current stops, the OCV goes back to equilibrium voltage through the Na phase change. FIG. 4B shows Lithium contents as a function of Na phase during electrochemical assisted ion exchange process. Measured (solid balls), calculated (empty circles) based on voltages and capacities in FIG. 4A, and predicted (gray dash line) based on the equilibrium equation and evolution equation are shown. FIG. 4C shows chemical compositions at different progress points shown in FIG. 4B. FIG. 4D shows XRD patterns of original P3-Na_{0.67}CoO₂ and fully converted Li_{0.90}Na_{0.02}CoO₂. FIG. 4E shows an atomic resolution HAADF-STEM image of fully converted Li_{0.90}Na_{0.02}CoO₂ along [010] zone axis and the signal profile from the dashed area. Scale bar, 1 nm.

FIG. 5 shows a phase diagram of Li and Na interchange in layered cobalt oxides. Two-phase equilibrium between Li_{0.94}CoO₂ and Na_{0.48}CoO₂ divides the whole cation range into two different regions. In the region above the equilibrium line, dual ion exchange between LiₓCoO₂ and Na_{y}CoO₂ (y=x) or LiₓCoO₂ and LiₐNa_{b}CoO₂ (equilibrium composition) can be achieved. In the region below the equilibrium line, only Na_{y}CoO₂ exchanging with Li can be approached due to the strong structural Li preference. The kinetic barrier in this single exchange region is extremely large when the vacancy level is inadequate (A>0.72, A=a+b in LiₐNa_{b}CoO₂). The electrochemical assisted ion exchange pathway is highlighted with black arrows. The thickness of the shaded arrows indicates the driving force of the targeted ion in solutions (e.g. Na_{y}CoO₂ exchange with 1-1000 Li—Na and 1 M Li are shown by thin and thick arrows, respectively.).

FIGS. 6A-6D show phase separation and two-phase equilibrium Li_{0.94}CoO₂—Na_{0.46}CoO₂ exist in P2-Na_{y}CoO₂ exchange with 1-1000 Li—Na. FIG. 6A shows a Galvanostatic curve of P2-Na_{y}CoO₂ in the range of 0.37<y<0.87. FIG. 6B shows open-circuit voltage (OCV) curves of P2-Na_{y}CoO₂ (y=0.37, 0.47, 0.57, 0.67) during ion exchange. FIG. 6C shows chemical compositions of P2-Na_{y}CoO₂ (y=0.37, 0.47, 0.57, 0.67) after 24 hours ion exchange. Black dots and white dots are the Li contents and Na contents measured by ICP-MS. The dash lines are predicted Li and Na contents based on phase equilibrium. FIG. 6D shows XRD of P2-Na_{0.67}CoO₂ after 24 hours ion exchange. The separated Li phase located at 18.540 (2θ) is a Li full phase. Due to the same consideration as for the P3 case, it is assigned as Li_{0.94}CoO₂.

FIGS. 7A-7C show the established electrochemical assisted ion exchange can be conducted in 1-10000 Li—Na ACN. FIG. 7A shows electrochemical curves during the whole process. The OCV curves still show the four intermediate plateaus. FIGS. 7B, 7C show the electrochemical intercalation curves for 1^{st} inter (FIG. 7B, C/10) and 2^{nd} inter (FIG. 7C, C/40) shown in FIG. 7A. Four intermediate plateaus are also visible in 1-10000 Li—Na. The right panel shows the absolute current during intercalation.

### DETAILED DESCRIPTION

Methods for synthesizing layered lithium transition metal oxides from layered sodium transition metal oxides are provided. Also provided are electrodes for lithium-ion batteries that include the layered lithium transition metal oxides. Similarly, methods for the synthesis of layered sodium transition metal oxides from layered lithium transition metal oxides and electrodes for sodium-ion batteries that include the layered sodium transition metal oxides are provided. The methods couple electrochemical intercalation of alkali ions (Li⁺ or Na⁺) with ion-exchange to overcome the kinetic limitations of ion-exchange in layered alkali transition metal oxides having low vacancy concentrations.

One aspect of the invention provides a method of forming layered Li_{0.94}MO₂ from Na_{y}MO₂, where 0.57≤y≤0.67 and M represents cobalt (Co), manganese (Mn), or nickel (Ni). The development of this method may be attributed, at least in part, to two discoveries by the inventors. First, the inventors discovered that a two-phase equilibrium exists between Li_{0.94}MO₂ and Na_{y}MO₂, where 0.45<y<0.51, for the exchange of sodium ions with lithium ions in the starting Na_{y}MO₂, where 0.57≤y≤0.67. And, second, the inventors discovered that, while the Li_{0.94}MO₂ forms via the ion-exchange once the Li phase separates from the Na host phase, the Na phase goes through a series phase changes beginning with the Na_{y}MO₂ phase where 0.57≤y≤0.67, to the final equilibrated Na_{y}MO₂ phase, where 0.45<y<0.51, during the ion-exchange.

By coupling ion-exchange with electrochemical ion intercalation and controlling the phase equilibrium and vacancies during the ion-exchange process, the starting sodium transition metal oxide can be substantially completely transformed into the layered lithium transition metal oxide or a mixed solution of layered lithium and sodium transition metal oxides (i.e., LiₓNa_{y}MO₂, where 0<x<1 and 0<y<0 and M is Co, Mn, or Ni) can be formed. The exchange of sodium ions with lithium ions in the layered transition metal oxides is a fully reversable process. This controllable and reversible electrochemically assisted ion-exchange process enables the synthesis of meta-stable layered lithium transition metal oxides, layered sodium transition metal oxides, and mixed layered lithium and sodium transition metal oxides that cannot be synthesized directly by more conventional methods, such as solid-state synthesis. As such, the present methods enlarge the layered oxide library for electrodes for both lithium-ion batteries and sodium-ion batteries.

One embodiment of a method for synthesizing a layered oxide having the formula LiₓNa_{y}MO₂, where 0<x<1 and 0<y<1 and M is Co, Mn, or Ni, includes the steps of: (a) providing a layered cobalt transition metal oxide having the formula Na_{y}MO₂, where 0.57≤y≤0.67; (b) conducting a first cation-exchange on the Na_{y}MO₂, where 0.57≤y≤0.67, in a solution containing dissolved lithium ions to convert the Na_{y}MO₂, where 0.57≤y≤0.67, into a material comprising discrete phases of Li_{0.94}MO₂ and Na_{y}MO₂, where 0.45<y<0.51; (c) conducting an electrochemical intercalation of lithium ions into the material to increase the Li_{0.94}MO₂ fraction in the material and regenerate Na_{y}MO₂, where 0.57≤y≤0.67; and (d) conducting an additional cation-exchange on the material in the solution containing dissolved lithium ions to further increase the Li_{0.94}MO₂ fraction in the material and convert the Na_{y}MO₂, where 0.57≤y≤0.67, back into Na_{y}MO₂, where 0.45<y<0.51. Steps (c) and (d) may be repeated multiple times to increase the phase fraction of the Li_{0.94}MO₂ in the material until a desired phase fraction is achieved. By way of illustration, steps (c) and (d) can be cycled until substantially complete ion-exchange is achieved, where a substantially complete ion exchange results in a phase fraction of Li_{0.94}MO₂ of at least 90 mol. % in the final material. This includes embodiments in which the phase fraction of Li_{0.94}MO₂ in the final material is at least 95 mol. % and at least 98 mol. %.

It is advantageous to use a thermodynamically stable phase of the Na_{y}MO₂, where 0.57≤y≤0.67, as the starting material for the Li_{0.94}MO₂ synthesis. For example, P2-Na_{0.67}MO₂ or P3-Na_{0.67}MO₂ can be used. However, other stable or meta-stable layered sodium transition metal oxides can also be used.

The first sodium-lithium cation exchange of the method is carried out on the starting Na_{y}MO₂, where 0.57≤y≤0.67, in a solution comprising dissolved lithium ions (Li⁺) The cation-exchange may be carried out at room temperature (23° C.) or near room temperature (for example, at temperatures in the range from 20° C. to 30° C.). However, higher temperatures can be used. Due to kinetic limitations on the cation-exchange, the exchange does not go to completion. Instead, the result of the initial cation-exchange is a two-phase material comprising Li_{0.94}MO₂ and Na_{y}MO₂, where 0.45≤y≤0.51. In order to increase the phase fraction of Li_{0.94}MO₂ in the material, the ion-exchange is followed by an electrochemical intercalation of lithium ions into the material. This is accomplished by applying a potential (an “intercalation potential”) across the material. Under the influence of this potential, lithium ions in the solution migrate into the layered structure of the alkali transition metal oxides. As a result, the phase fraction of Li_{0.94}MO₂ in the material is increased and the Na_{y}MO₂, 0.45<y<0.51, phase is converted back into Na_{y}MO₂, 0.57≤y≤0.67. This material can then undergo an additional cation-exchange step to further increase the phase fraction of Li_{0.94}MO₂ in the material, while regenerating the equilibrium Na_{y}MO₂ phase, where 0.45<y<0.51.

Notably, because the layered oxides are highly selective for lithium ions over sodium ions, the electrochemical intercalation assisted ion-exchange can be carried out in a solution in which sodium ions are in excess over lithium ions. In fact, dilute solutions in which the lithium ion concentration is lower than 1 millimolar (mM), lower than 0.5 mM, or lower than 0.2 mM (e.g., in the range from about 0.1 mM to 1 mM) can be used. However, the methods can also be carried out in higher concentration solutions and in solutions in which the lithium ions are in excess.

Another aspect of the invention provides methods for the synthesis of a layered oxide having the formula Na_{y}MO₂, where 0.45<y<0.51 and M is Co, Mn, or Ni, from the corresponding layered LiMO₂. One embodiment of such a method includes the steps of. providing a layered lithium transition metal oxide having the having the formula LiMO₂; conducting an electrochemical deintercalation of lithium ions from the material to convert the LiMO₂ into Li_{0.4}MO₂; and conducting a cation-exchange on the Li_{0.4}MO₂ in a solution containing dissolved sodium ions to convert the Li_{0.4}MO₂ into a material comprising Na_{y}MO₂ phases, where 0.45≤y≤0.51. During the electrochemical deintercalation, a potential is applied across the LiMO₂ to force lithium ions out of the material. The subsequent cation exchange between sodium and lithium ions can completely (100%) or substantially completely (>90%, 95%, or 98%) convert the LiMO₂ into Na_{y}MO₂, where 0.45<y<0.51.

The lithium phase-pure or lithium phase-rich layered transition metal oxides and the sodium phase-pure or sodium phase-rich layered transition metal oxides can be used as the active materials in electrodes for lithium-ion batteries and sodium-ion batteries, respectively. The layered transition metal oxides may be supported on an electrically conductive support substrate, such as a metal substrate, and/or may be mixed with an electrically conductive powder, such as a metal or carbon powder, to form the electrodes. Optionally, a binder may be used to enhance the mechanical integrity of the electrodes.

One embodiment of a lithium-ion battery includes: a battery compartment; a cathode comprising a material comprising discrete Li_{0.94}MO₂ and Na_{y}MO₂ phases, where 0.45<y<0.51, wherein the phase fraction of the Li_{0.94}MO₂ in the material is at least 90 mol. %; an anode in electrical communication with the cathode; an electrically conductive wire connecting the anode to the cathode; and a lithium ion-conductive electrolyte disposed between the anode and the cathode. Typically, the lithium-ion battery will also include a separator, such as an ion-permeable membrane, in the electrolyte between the anode and the cathode in order to physically separate the anode from the cathode.

One embodiment of a sodium-ion battery includes: a battery compartment; a cathode comprising a material comprising a Na_{y}MO₂ phase, where 0.45<y<0.51, wherein the phase fraction of the Na_{y}MO₂ in the material is at least 0.98 mol. %; an anode in electrical communication with the cathode; an electrically conductive wire connecting the anode to the cathode; and a sodium ion-conductive electrolyte disposed between the anode and the cathode. Typically, the sodium-ion battery will also include a separator, such as an ion-permeable membrane, in the electrolyte between the anode and the cathode in order to physically separate the anode from the cathode.

### Example

The Example provides a detailed discussion of predictive ion exchange pathways and reveals an ion exchange mechanism for Li and Na in layered oxides using cobalt oxides as models. Counterintuitively, using Li ions at extremely low molar ratios (e.g. 1-1000 molar ratio Li—Na) and small excess (e.g. 18% excess of Li to target amount), near equilibrium exchange with Na_{y}CoO₂ can be achieved by taking advantage of structural Li preference. Instead of forming LiₓCoO₂ with the same cation content (x=y), the structure nucleates a Li_{0.94}CoO₂ phase that has the smallest potential difference with the Na phase, which drives the Na phase change to form the equilibrium between Na_{0.48}CoO₂ and Li_{0.94}CoO₂. The phase separation and equilibrium behaviors allow for the prediction of not only the final compositions and phases, but also the intermediate states to map out the kinetic pathways. The phase separation behavior was also captured at far from equilibrium conditions with high Li concentrations and large Li excesses. This Example also demonstrates that Li_{0.94}CoO₂ nucleation is a critical step to initiate the ion exchange, following which the reaction proceeds with either a diffusion-limited (high Li ratio) or a surface reaction-limited (low Li ratio) mechanism. Additionally, a large kinetic energy barrier at low vacancy levels is also identified, which defines the accessible and inaccessible ion exchange pathways. Guided by the understanding in vacancy-dependent ion preference and diffusion barriers, Na_{y}CoO₂ (˜98% Na purity) conversion from the parent LiₓCoO₂ was identified for the first time and Na_{y}CoO₂ conversion to Li_{0.94}CoO₂ (˜98% Li purity from 1-1000 molar ratio Li—Na) via electrochemical assisted ion exchange was also identified, with the latter being of significant importance for Li extraction.

Na_{0.48}CoO₂ and Li_{0.94}CoO₂ Phase Equilibrium

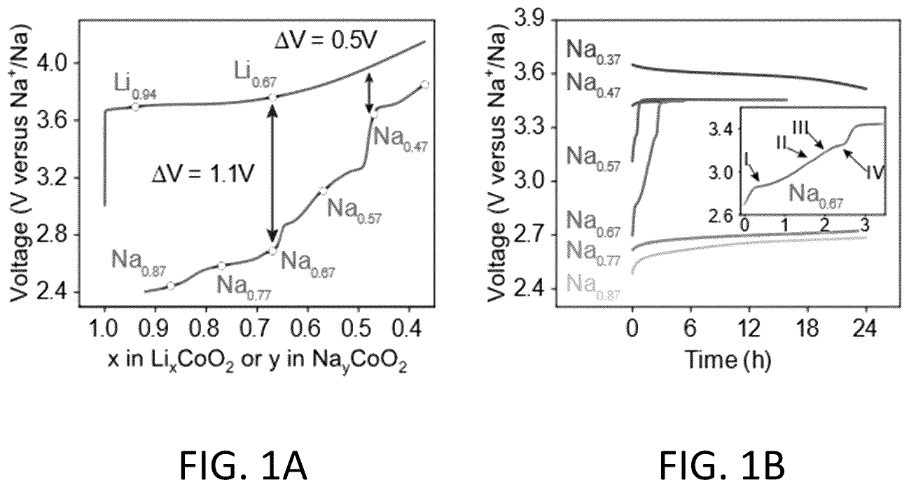

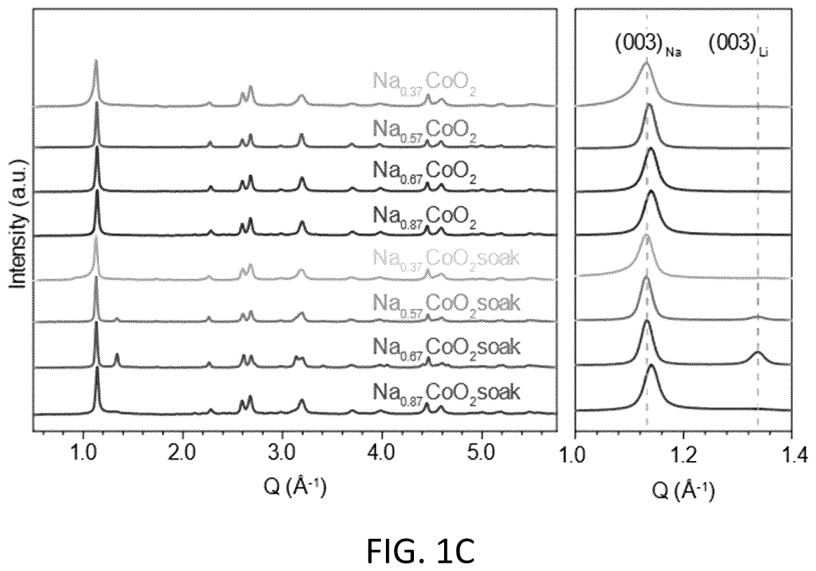

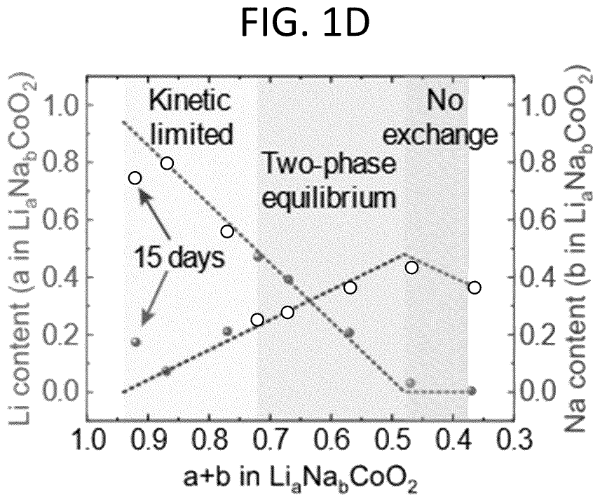

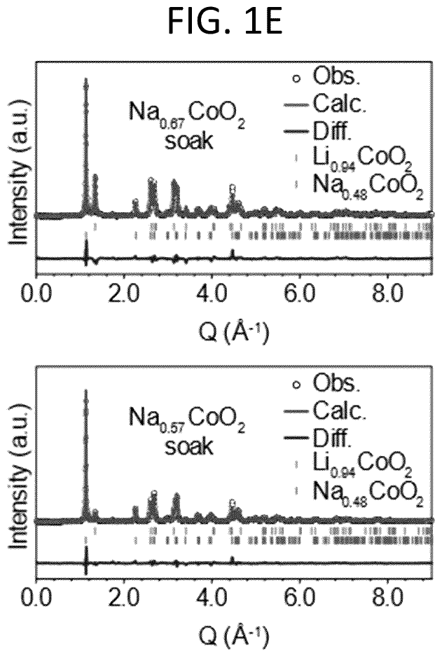

Platelet-like P3-Na_{0.67}CoO₂ particles were used as model materials to systematically explore the ion exchange process. P3-Na_{0.67}CoO₂ particles have a size around 100-500 nm with a thickness less than 100 nm. FIG. 1A shows the galvanostatic curves of O3—LiₓCoO₂ and P3-Na_{y}CoO₂ at slow kinetics (C/80) which represent mostly their thermodynamic differences. 03—LiₓCoO₂ and P3-Na_{y}CoO₂ have distinct phase transformations with respect to vacancy change. Importantly, the significant voltage differences between LiₓCoO₂ and Na_{y}CoO₂ (e.g. ˜1.1V at x=y=0.67) shown on the galvanostatic curves indicates the preference for Li. Such structural Li preference is a function of the vacancy level wherein the Li preference increases as the vacancy level decreases.

To control the ion exchange and limit possible kinetic pathways, the ion exchange reaction was designed near equilibrium using a low Li ratio (1-1000 Li—Na, 1 mM Li and 1 M Na in acetonitrile (ACN) solution, unless otherwise specified). Na_{y}CoO₂ with varying y (y=0.37, 0.47, 0.57, 0.67, 0.77, 0.87) were prepared to investigate the ion exchange at different structural Li preferences (as marked by DV=V_{LixCoO2}-V_{NayCoO2}). The open-circuit voltage (OCV) of P3-Na_{y}CoO₂ during ion exchange was monitored. Interestingly, the OCV curve of Na_{0.67}CoO₂ has a shape similar to the galvanostatic curve at the range between y=0.67 and y=0.48 but with an additional final plateau at the voltage of 3.45V (FIG. 1). Four intermediate plateaus (I, II, III, and IV) on the galvanostatic charging curve also appear on the OCV curve of Na_{0.67}CoO₂ (inset of FIG. 1), which indicates the occurrence of similar phase transformations. The differential capacity curve of P3-Na_{0.67}CoO₂ has four peaks in the voltage range of 2.8V-3.6V, which correspond to the four plateaus shown in the galvanostatic charging curve. This “pseudo-charging” behavior (potential changing like charging but without redox reactions) suggests that ion exchange with Li can induce the structure change of the starting Na_{y}CoO₂. The “pseudo-charging” is also observed at Na content (y) of 0.57. However, for other sodium contents (y=0.37, 0.47, 0.77, and 0.87), no “pseudo-charging” behavior was observed.

Synchrotron X-ray diffraction (XRD) was conducted to identify the Li and Na phases after ion exchange. For parent Na_{y}CoO₂ before ion exchange, the (003) peaks gradually left-shifted as the sodium content y decreased, corresponding to the expansion of interlayer distance (FIG. 1C). After ion exchange, rather than forming the intermediate phase observed at the elevated temperature, a new Li phase appeared for Na_{0.57}CoO₂ and Na_{0.67}CoO₂ which showed “pseudo-charging” behaviors. The (003) peak of the new Li phase was at the same position and assigned to Li_{0.94}CoO₂. Accompanied by the Li phase appearance, the Na (003) peaks of the Na_{0.57}CoO₂ and Na_{0.67}CoO₂ left-shifted to the position of the Na_{0.48}CoO₂ phase (see Methods for Li_{0.94}CoO₂ and Na_{0.48}CoO₂ phase assignment). Varying the ion exchange time did not affect the Li contents for Na_{0.67}CoO₂, which illustrates the equilibrium for Na_{0.67}CoO₂had been established within 12 hours. This, and the continuation of the final plateau (FIG. 1), indicate the ion exchange process already reached a steady state and the formed Li_{0.94}CoO₂ phase and Na_{0.48}CoO₂ phase were in equilibrium. However, for Na_{0.37}CoO₂ and Na_{0.87}CoO₂, no obvious Li phase was observed after 24 h ion exchange based on synchrotron XRD characterization.

If two-phase equilibrium between Li_{0.94}CoO₂ and Na_{0.48}CoO₂ exists in the ion exchange process, the Li and Na contents a and b can be calculated in the structure LiₐNa_{b}CoO₂ based on the vacancy level (see equations in Methods). The chemical compositions are Li_{0.47}Na_{0.25}CoO₂, Li_{0.39}Na_{0.28}CoO₂, and Li_{0.21}Na_{0.36}CoO₂ after ion exchange for the starting materials Na_{0.72}CoO₂, Na_{0.67}CoO₂, and Na_{0.57}CoO₂. The excellent agreement between the measured chemical compositions and predicted chemical compositions based on the equilibrium equation confirms the two-phase equilibrium between Li_{0.94}CoO₂ and Na_{0.48}CoO₂ (FIG. 1D), which is also proved by Rietveld refinement results (FIG. 1E). However, based on the two-phase equilibrium, Na_{0.77}CoO₂ and Na_{0.87}CoO₂ should convert to Li_{0.59}Na_{0.18}CoO₂ and Li_{0.50}Na_{0.07}CoO₂, respectively. The experiment results showed that the final compositions (Li_{0.21}Na_{0.56}CoO₂ and Li_{0.07}Na_{0.50}CoO₂, respectively) had much less Li than the predicted value, indicating kinetic limitations. Such kinetic barrier is so high that even after 15 days of ion exchange, the Li content a was still 0.17 instead of 0.90 for Na_{0.92}CoO₂, and even when the exchange solution was changed to 1 M Li, the ion exchange could not go to completion. A large kinetic barrier may be partially due to the vastly different diffusion coefficients (approximately two orders of magnitude) from the ˜30% to ˜10% vacancy level. The following section demonstrates that this kinetic limitation can be overcome via an electrochemical assisted ion exchange process.

Based on the final compositions and phases, the ion exchange process was divided into three different regions. First, in the range of 0.48≤a+b≤0.72 (FIG. 1D), phase equilibrium was established between Li_{0.94}CoO₂ and Na_{0.48}CoO₂. Second, with 0.72≤a+b<0.94 (FIG. 1D), such as starting from Na_{0.77}CoO₂ and Na_{0.87}CoO₂, even though two-phase equilibrium was predicted, the ion exchange could not complete due to large kinetic barriers at low vacancy levels. Third, for 0.37≤a+b<0.48 (FIG. 1D), no “pseudo-charging” behavior was observed and Na_{y}CoO₂ was the stable phase without ion exchange. As indicated by the potentials in FIG. 1A, with y in Na_{y}CoO₂ decreasing to 0.48, the structural preference for Li decreased significantly (DV decreases from 1.1V to 0.5V). With the low starting Li ratio (1-1000 Li—Na), the driving force was insufficient to initiate the ion exchange. By using a higher Li ratio (1 M Li), the ion exchange of Na_{0.37}CoO₂ was complete, confirming the limitation was from the thermodynamic driving force. However, such ion exchange does not follow the two-phase equilibrium route between Li_{0.94}CoO₂ and Na_{0.48}CoO₂, since the cation content is out of the equilibrium range.

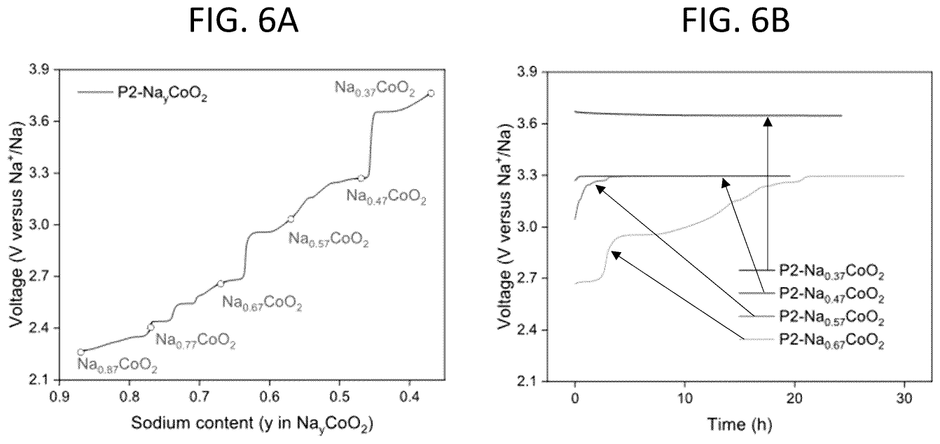

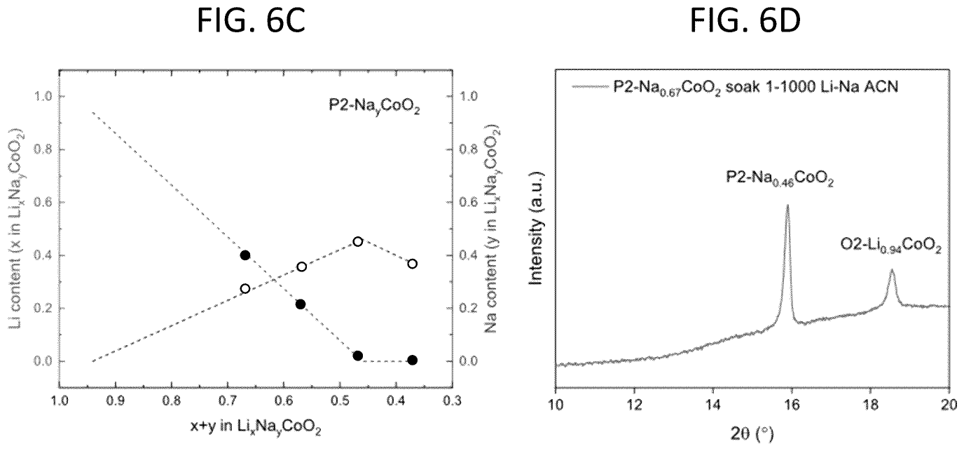

This phase separation and equilibrium phenomenon accompanied by the “pseudo-charging” behavior is not unique to the P3-Na_{y}CoO₂ system. Similar phenomena were observed for P2-Na_{y}CoO₂ exchanged with Li in 1-1000 Li—Na CAN (FIG. 6). Based on the same characterization, the equilibrated Li phase and Na phase in the P2-Na_{y}CoO₂ system were assigned as O2—Li_{0.94}CoO₂ and P2-Na_{0.46}CoO₂, respectively.

### Resolving Ion Exchange Pathways

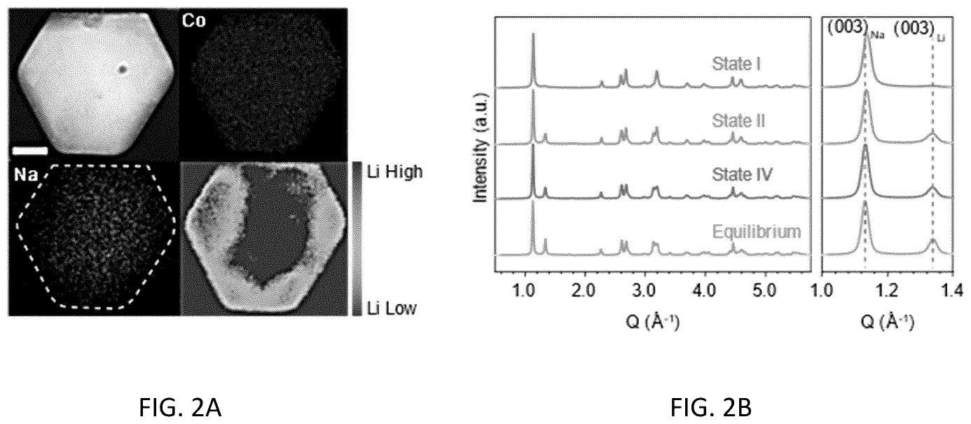

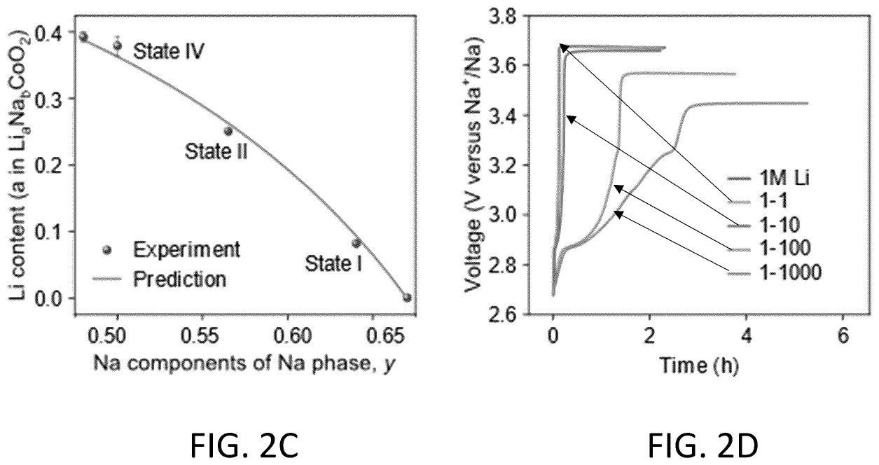

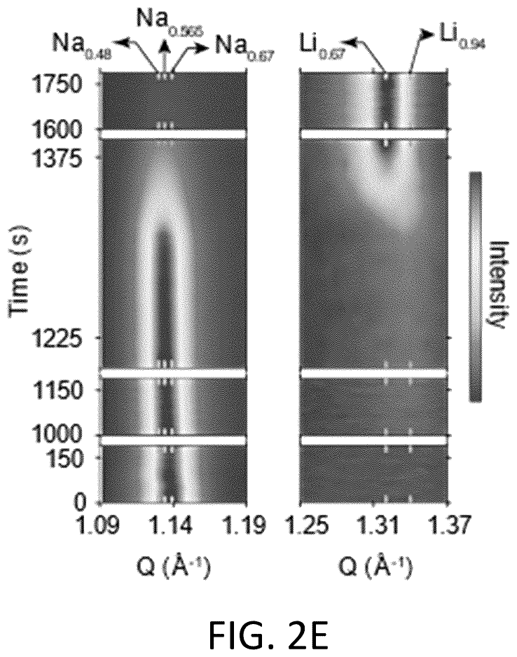

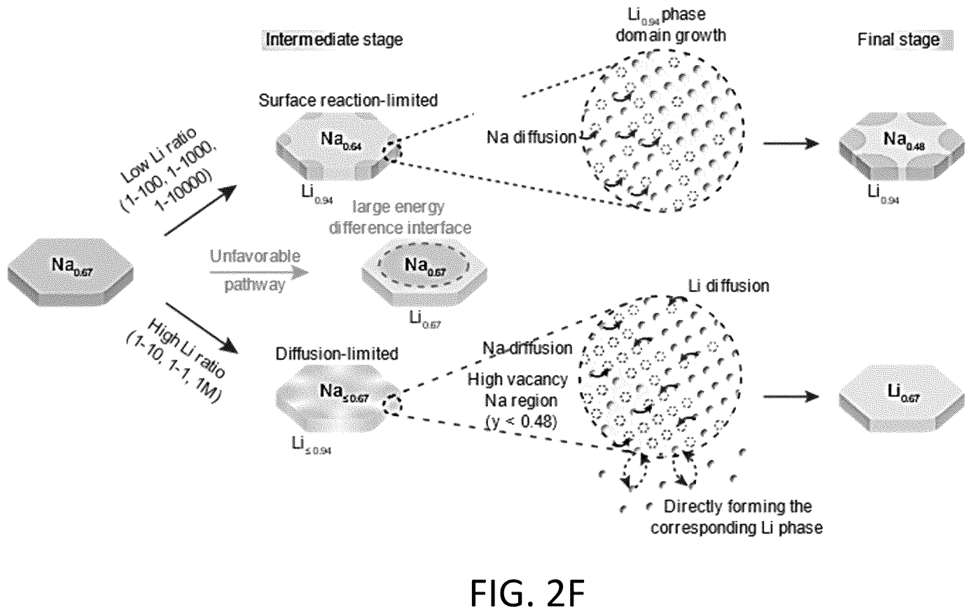

Before resolving ion exchange pathways, it was first necessary to understand the phase equilibrium between Li_{0.94}CoO₂ and Na_{0.48}CoO₂. From the galvanostatic curves, Li_{0.94}CoO₂ and Na_{0.48}CoO₂ have similar potentials that allow the structure to establish equilibrium. In contrast, direct conversion of Na_{0.67}CoO₂ to Li_{0.67}CoO₂ will cause a large potential difference at the reaction interface which could lead to structural instability. Moreover, the phase equilibrium between Li_{0.94}CoO₂ and Na_{0.48}CoO₂ indicates that charge redistribution between Co³⁺/Co⁴⁺ must occur during the phase change. The in-plane electron resistivity is much lower than that of out-of-plane and across-particle electron resistivities. Therefore, in-layer intra-particle phase separation would be the most feasible pathway to establish the phase equilibrium. Scanning transmission electron microscopy energy-dispersive x-ray spectroscopy (STEM EDX) and electron energy loss spectroscopy (EELS) were then performed to resolve the Na and Li distribution, respectively. The results proved the in-layer intra-particle phase separation with Na mainly in the center and Li at the corners and edges in a single hexagonal-like particle (FIG. 2A). Despite the fact that Li and Na are commonly thought to not coexist in one layer, this nonuniform distribution of Li and Na in the basal plane indicates that the ion exchange process does not follow the slab-by-slab exchange route.

To gain the full picture of ion exchange pathways, several intermediate states during ion exchange were characterized by synchrotron XRD. The ion exchange process was quenched at the I, II, and IV plateaus, and denoted as the state I, II, and IV respectively. At state I, the structure directly formed Li_{0.94}CoO₂ (FIG. 2B) instead of Li_{0.67}CoO₂ as proposed in the slab gliding model. (Tournadre, F. et al., Journal of Solid State Chemistry 177, 2803-2809 (2004).) The formation of Li_{0.94}CoO₂ is favorable, since it has the smallest potential difference to Na_{y}CoO₂ (y>0.48). The observed phase transformation indicates that the ion exchange started with Li_{0.94}CoO₂ nucleation, and then the Na phase changed from Na_{0.67}CoO₂ to the final equilibrated phase Na_{0.48}CoO₂ as the Li phase grew. The persistence of the Li_{0.94}CoO₂ phase during the entire ion exchange allowed for the determination of the chemical composition and phase evolution of LiₐNa_{b}CoO₂ based on the evolution equation (Methods). The chemical compositions calculated based on the evolution equation, inductively coupled plasma mass spectrometry (ICP-MS) measurement, and Rietveld refinement all showed good agreement, supporting the proposed evolution pathway (FIG. 2C).

To understand whether the proposed phase separation process is a general evolution pathway, the ion exchange process was studied at different Li—Na ratios. All the OCV curves showed “pseudo-charging” behavior in 1-1000, 1-100, 1-10, 1-1 (molar ratio Li—Na, Na concentration was fixed as 1 M), and 1 M Li acetonitrile solution, but with different plateau numbers and final plateau potentials. The difference in final plateau potentials can be understood from the Nernst shift of the potential of the Li_{0.94}CoO₂ phase in solutions with different Li concentrations (FIG. 2D). The four intermediate plateaus during Na phase transformation were still visible in 1-100 and 1-10 cases. For 1-1 and 1 M Li, the fast exchange kinetics makes capturing intermediate steps challenging. But the appearance of the first plateau was observed. In situ synchrotron XRD was then performed for the case of 1 M Li. The emergence of the Li_{0.94}CoO₂ (003) peak at 1225 s˜1375 s (FIG. 2E) demonstrated again that the exchange process initiates via Li_{0.94}CoO₂ nucleation. However, in this condition, both Li and Na phases changed after Li_{0.94}CoO₂ nucleation, as shown by the left-shift of both Li and Na peaks (FIG. 2E), and then finally a single Li_{0.67}CoO₂ phase was established with the disappearance of the Na phase.

This result points to two ion exchange routes following Li_{0.94}CoO₂ nucleation. When the solution Li ratio is low (e.g. 1-1000 Li—Na), Li exchange with surface Na is the rate-limiting step (surface reaction-limited). Structural Na can diffuse to fill up the vacancy formed from Li_{0.94}CoO₂ phase nucleation and growth. Therefore, the Na phase change and a persistent Li_{0.94}CoO₂ phase in the whole exchange process (FIG. 2F) were only observed. When the solution Li ratio is high (e.g. 1 M Li), Li can quickly exchange with surface Na and nucleate a Li_{0.94}CoO₂ phase. The fast nucleation and growth of the Li_{0.94}CoO₂ phase leaves nearby domains with much higher vacancy levels. In this case, bulk Na diffusion alone cannot catch up with the ion exchange rate (diffusion-limited) and the diffusion of both Li and Na occurs to avoid forming unstable interfaces with large potential differences. Additionally, high vacancy Na phases (Na_{y}CoO₂, y≤0.48) can directly exchange with solution Li, skipping the Li_{0.94}CoO₂ nucleation when the solution Li ratio is high (e.g. 1 M Li). Hence, in the P3-Na_{y}CoO₂ in-situ synchrotron XRD, the left-shift of the Na peak caused by Li_{0.94}CoO₂ nucleation and growth was observed. Then the Li peak left-shifted to Li_{0.67}CoO₂ due to the merging of Li_{0.94}CoO₂ with high vacancy Li domains (formed from the direct conversion of high vacancy Na phases). The diffusion-limited ion exchange was also observed for P2-Na_{y}CoO₂ exchanging with 1 M Li. Due to the large particle size, both Li_{0.94}CoO₂ and high vacancy LiₓCoO₂ (x<0.46) were observed without merging accompanied by a high vacancy Na_{y}CoO₂ (y≤0.46) phase.

Pure Na_{y}CoO₂ from LiₓCoO₂ Via Reversed Ion Exchange

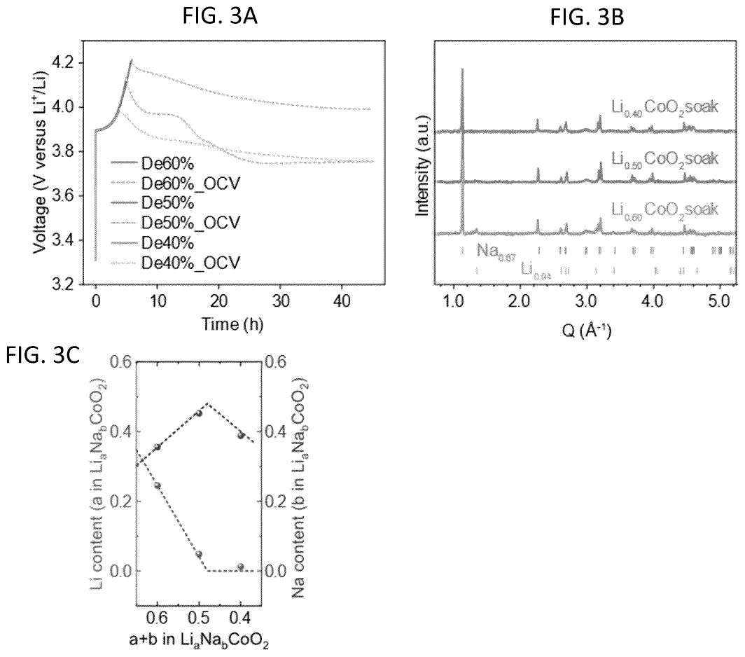

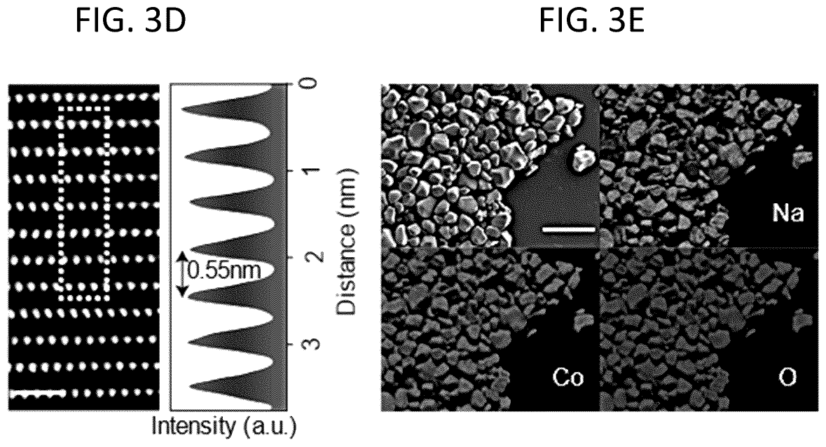

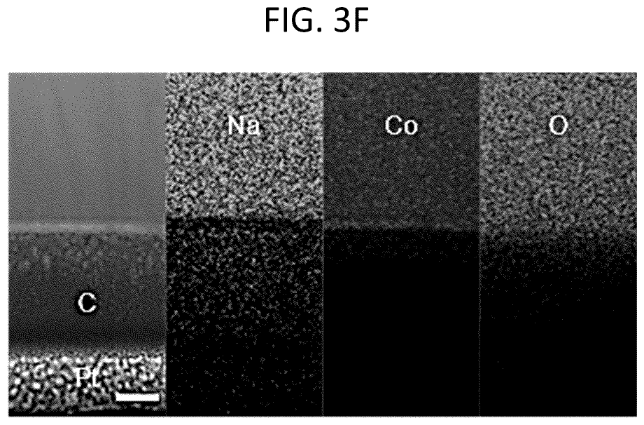

Despite successful ion exchange to make Li cathodes, the reversed ion exchange with Na replacing the structural Li to achieve pure Na_{y}CoO₂ has not been reported before. Starting with a full Li structure without any vacancy only allows less than 1% of exchange at elevated temperature. (Xue, Z. et al. ACS Appl. Mater. Interfaces 10, 27141-27149 (2018).) Here, it was demonstrated that pure Na_{y}CoO₂ can be achieved from 03—LiₓCoO₂ when high structural Li preference regions are avoided. The phase equilibrium between Li_{0.94}CoO₂ and Na_{0.48}CoO₂ indicates that interconversion between Li and Na layered oxide is possible outside the range of phase equilibrium, which is a+b>0.94 for Li and a+b≤0.48 for Na. Li_{0.40}CoO₂, Li_{0.50}CoO₂, and Li_{0.60}CoO₂ were prepared for the demonstration. The OCV curves went through a series of slopes and plateaus indicating the occurrence of ion exchange (FIG. 3A). After reaching equilibrium, Li_{0.40}CoO₂ and Li_{0.50}CoO₂ only showed Na diffraction peaks, whereas Li_{0.60}CoO₂ had both Li and Na diffraction peaks (FIG. 3B). Li contents a are 0.01 (˜98% Na purity), 0.05, and 0.24 confirmed by ICP-MS (FIG. 3C), which agree with the predicted compositions of Na_{0.4}CoO₂, Li_{0.04}Na_{0.46}CoO₂, and Li_{0.25}Na_{0.35}CoO₂, respectively, based on the phase equilibrium. The exchanged Na_{0.48}CoO₂ from Li_{0.48}CoO₂ was used for further characterization. STEM imaging showed a 5.5 A interlayer distance confirming the Na_{0.48}CoO₂ phase (FIG. 3D). The uniform distribution of Na EDS signal on both the particle ensemble level (SEM, FIG. 3E) and the single particle level (STEM, FIG. 3F) was observed, indicating the completion of Na ion exchange with the structural Li.

### Overcoming the Kinetic Barrier by Electrochemical Assisted Ion Exchange

Next, a strategy was demonstrated to avoid the inaccessible ion exchange pathway and realize the formation of Li_{0.94}CoO₂ from Na_{0.67}CoO₂ at a low Li ratio (1-1000 Li—Na) and small Li excess (18% excess of Li to target amount, Methods). The phase equilibrium predicted a pure Li phase at a+b>0.94. However, in the range of 0.72≤a+b≤0.94, the final exchanged products did not follow the prediction due to the large kinetic barriers. Inspired by the established structure evolution pathway, the ion exchange was designed to start from the Na_{0.67}CoO₂ phase with enough vacancies and increase the cation content a+b to ˜0.94 by multiple electrochemical intercalations while maintaining 0.48≤y≤0.67 in the Na_{y}CoO₂ phase for fast ion exchange.

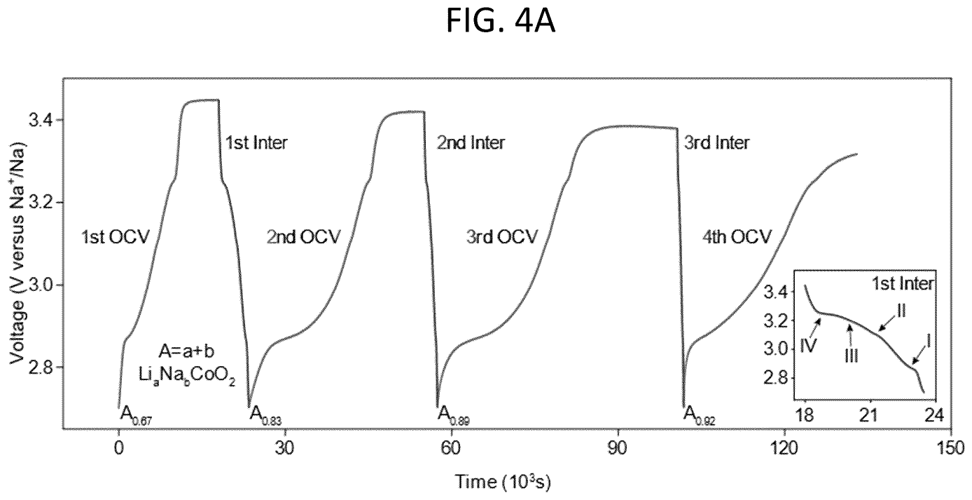

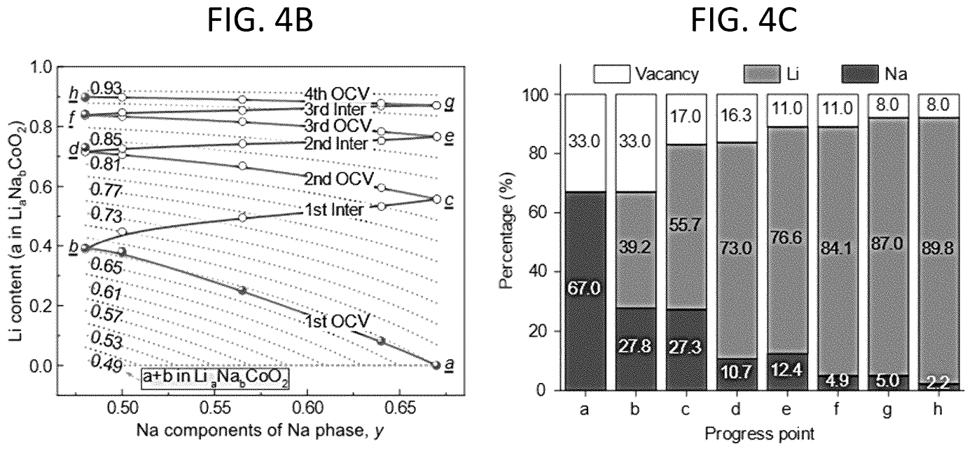

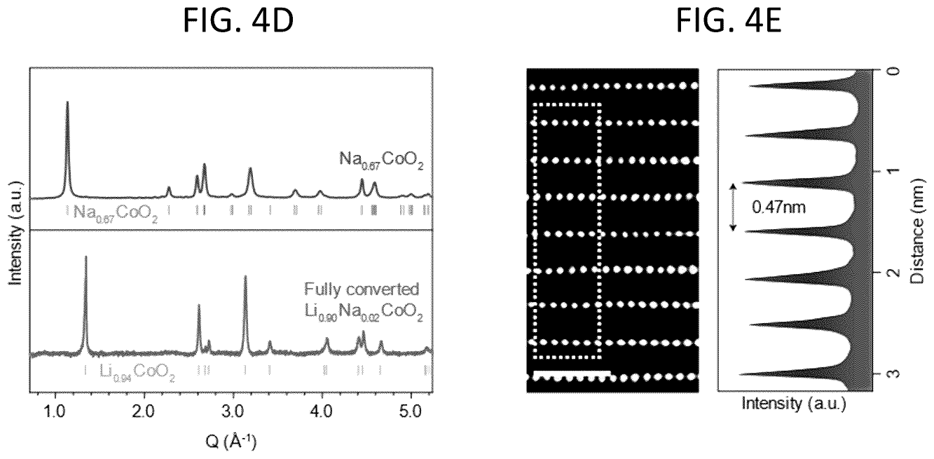

As shown in FIG. 4A, after the first phase equilibrium, the electrode was intercalated to the starting potential of Na_{0.67}CoO₂. Then the process was repeated until the electrode reached its full capacity. Due to the ongoing exchange, the potential went back to the equilibrium potential once the intercalation current was stopped. Moreover, the intercalation voltage profile also shows the same four plateaus, which correspond to the transformation from Na_{0.48}CoO₂ to Na_{0.67}CoO₂. After three times of intercalation, the total amount of alkali-metal ions reached 0.92 (a+b=0.92 for LiₐNa_{b}CoO₂).

Even though the intercalation process is accompanied by a simultaneous ion exchange process, the chemical composition evolution during the whole process can be predicted using the Na component in the Na phase reflected by the electrochemical potential. The measured compositions at intermediate steps and the calculated compositions based on the evolution equation show excellent matching (FIGS. 4B-4C). This proves again that the ion exchange process is governed by the two-phase equilibrium in the whole range of 0.48<a+b≤0.94. With the electrochemical assisted ion exchange, a complete exchanged lithium cobalt oxide (Li_{0.90}Na_{0.02}CoO₂) was obtained. A minor 2% of Na, based on ICP-MS, was detected in the structure, which also existed for the ion exchange conducted with a high Li ratio and large excess (Li_{0.95}Na_{0.016}CoO₂ was obtained from exchange in 5 M LiGH and LiCl solution (1:1) for 19 hours). The structural characterization shows pure XRD patterns of Li_{0.94}CoO₂ (FIG. 4D). The corresponding 4.7 A interlayer spacing was also observed for Li_{0.90}Na_{0.02}CoO₂ by HAADF-STEM which supports the successful conversion to Li_{0.94}CoO₂ (FIG. 4E).

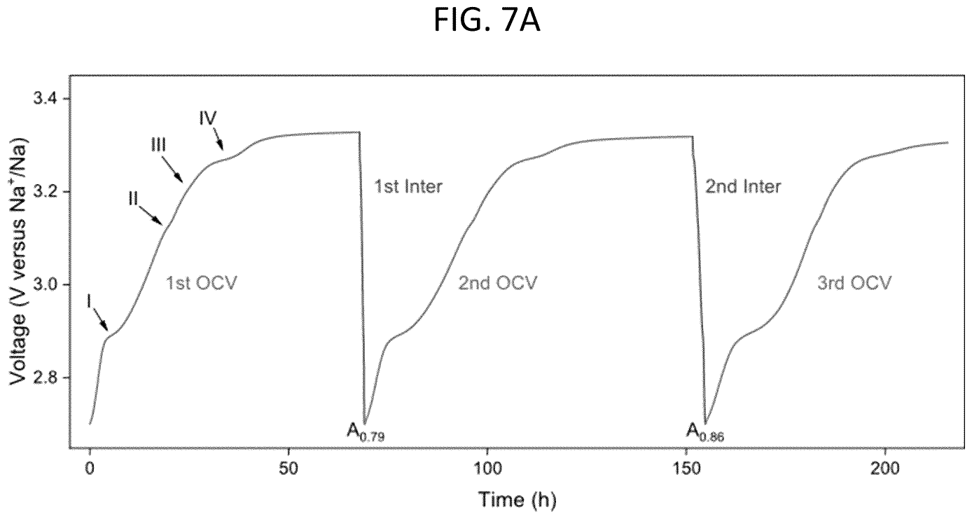

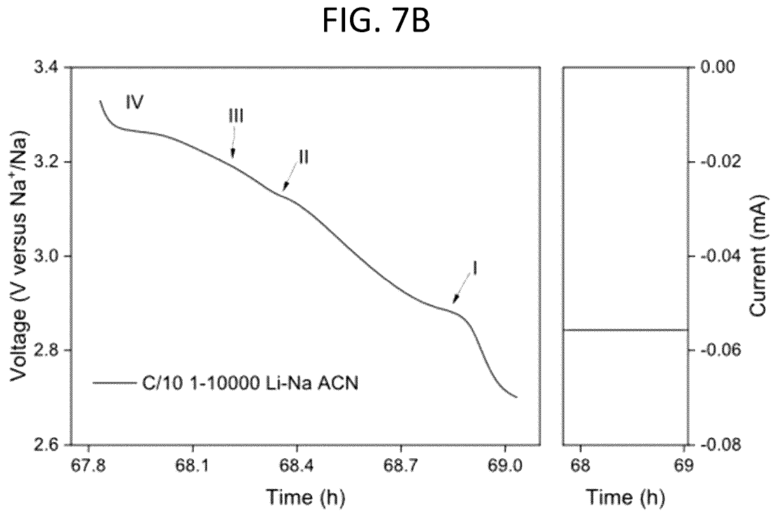

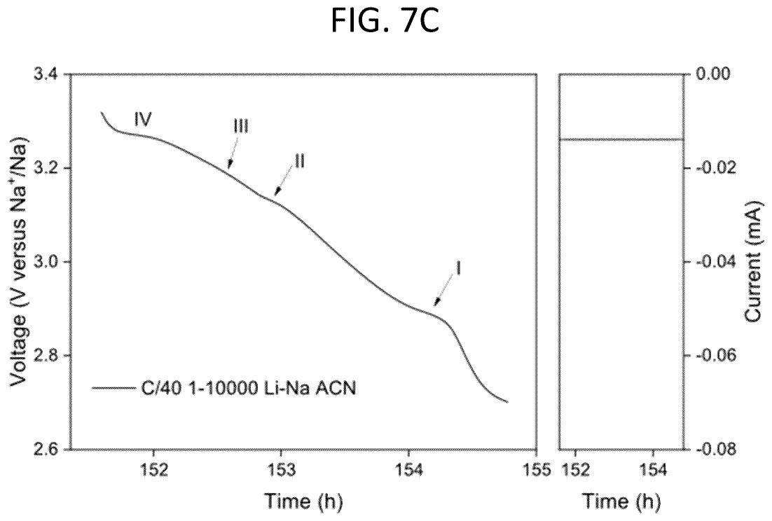

Since the Na_{0.67}CoO₂ to Li_{0.94}CoO₂ conversion was done in 1-1000 Li—Na solution, it marks the excellent structural selectivity (4.5×10⁴, Methods) for layered oxide to enable Li extraction application with ˜98% Li purity. Moreover, it was demonstrated that the Li extraction can also be achieved using an even lower Li ratio (1-10000 Li—Na) (FIGS. 7A-7C).

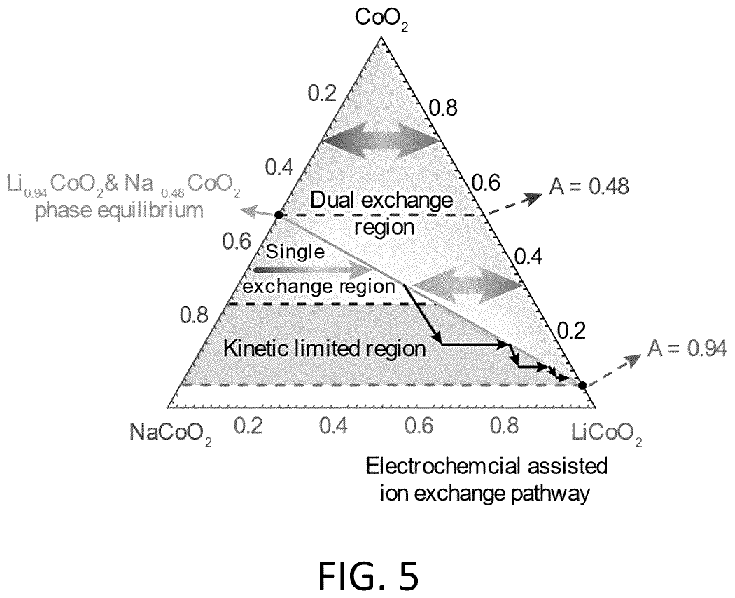

Finally, all the accessible conversion pathways for Li and Na ion exchange in layered cobalt oxide were labeled (FIG. 5). All LiₓCoO₂ can be achieved from Li exchanging with Na_{y}CoO₂ given sufficient driving force and avoiding the kinetic-limited regions. However, only Na_{y}CoO₂ with y≤0.48 can be achieved at large Na concentrations and excesses due to the extremely strong structural Li preference. These results indicate that the phase equilibrium between Li_{0.94}CoO₂ and Na_{0.48}CoO₂ plays a key role in determining the ion exchange pathway in all cation ranges.

This Example also showed that vacancy-dependent large thermodynamic Li preference can trigger the exchange of Na_{y}CoO₂ at an extremely low Li ratio (e.g. 1-10000) and small excess. This Example resolved general ion exchange pathways that Li_{0.94}CoO₂ nucleation initiated the ion exchange and were followed by surface reaction-limited and diffusion-limited exchange pathways at near equilibrium (e.g. 1-1000) and far from the equilibrium (e.g. 1 M Li) conditions, respectively. Guided by the understanding of the ion exchange mechanism, Na_{y}CoO₂ conversion from the parent LiₓCoO₂ was demonstrated for the first time, and Na_{y}CoO₂ conversion to Li_{0.94}CoO₂ was realized via electrochemical assisted ion exchange. This work opens new opportunities for ion exchange in predictive synthesis and Li extraction.

### Methods

### Sample Preparation

P3-Na_{0.67}CoO₂ and P2-Na_{0.67}CoO₂ were synthesized via a known solid-state method. (Lei, Y. et al., Chem. Mater. 26, 5288-5296 (2014).) Na₂O2 (Alfa, 95%) and CO₃O₄ (Alfa, 99.7%) were mixed in a stoichiometric ratio of Na:Co=0.68:1 (a slight excess of Na) in an Ar glovebox. 30 min high-energy ball-milling was treated before pressing the mixture into a pellet. The transferring step from the ball-milling container to the press dies was finished in the Ar glovebox as well to minimize air contact. The pellet was heated at 535° C. for 16 h to obtain P3-Na_{0.67}CoO₂ and at 700° C. for 16 h to obtain P2-Na_{0.67}CoO₂. After cooling down to ˜300° C., the pellet was transferred into the Ar glovebox and stored for later use. Electrode slurries were prepared by mixing the active material, conductive carbon (Super P, MTI), and binder (polyvinylidene fluoride, MTI) in an 8:1:1 weight ratio, together with N-methyl-2-pyrrolidone (NMP, Sigma-Aldrich). The mass loading was 2˜3 mg per electrode. Electrodes were made by coating slurries on the carbon cloth substrate.

### Electrochemical Test

All the electrochemical tests (including the OCV tests) were conducted in the three-electrode system using SP-300 potentiostat (BioLogic) in the Ar glovebox. The potential for the commercial LiCoO₂ in 1 M Li ACN charging is around 0.6 V versus the non-aqueous Ag⁺/Ag reference electrode (CH Instrument Inc.). Therefore, the potential of the reference electrode is around 3.0 V versus Na⁺/Na. All the plotted curves were manually shifted 3.0 V for better comparison. The counter electrodes LiFePO₄, NaFePO₄, or FePO₄ were chosen depending on the major cation in electrolytes. Electrolytes were prepared by dissolving LiClO₄ and (or) NaClO₄ into 30 mL acetonitrile (CAN) according to different ratios. 500 mL 1-10000 Li—Na CAN was used for validating the electrochemical assisted ion exchange method. C/80 was used for collecting the galvanostatic curves of P3-Na_{y}CoO₂ and P2-Na_{y}CoO₂. C/40 and C/10 were used to prepare Na_{y}CoO₂ electrodes and LiₓCoO₂ electrodes with different vacancies, respectively. C/10 was used in the electrochemical assisted ion exchange process.

Li_{0.94}CoO₂ and Na_{0.48}CoO₂ Phase Assignment

The newly appeared Li peak position matched well with Li_{0.94-1.0}CoO₂. (Menetrier, M. et al., Journal of Materials Chemistry 9, 1135-1140 (1999).) Considering the low electronic conductivity of LiₓCoO₂ at 0.94≤x≤1, which will induce a high energy barrier for Li insertion during ion exchange in a low Li—Na ratio solution, the newly appeared Li phase was assigned to Li_{0.94}CoO₂ instead of Li_{1.0}CoO₂. (Menetrier, M. et al., 1999; Daheron, L. et al. Chem. Mater. 20, 583-590 (2008).) The new Na phase had an interlayer distance of 5.55A, which corresponds to Na_{y}CoO₂ at 0.3≤y≤0.5. (Viciu, L. et al. Phys. Rev. B 73, 174104 (2006).) The galvanostatic curve (FIG. 1A) gave y=0.48 based on the final voltage, which was also confirmed by inductively coupled plasma mass spectrometry (ICP-MS).

### Equilibrium Equation and Evolution Equation

$$( 1 - x ) f + ( 1 - y ) ( 1 - f ) = c ,$$

where x is the Li component in the Li phase LiₓCoO₂, x=0.94 for the equilibrium condition and during evolution; y is the Na component in the Na phase Na_{y}CoO₂, y=0.48 for the equilibrium condition and 0.48<y<0.67 during evolution; f is the phase fraction of the Li phase; c is the total vacancy in the structure. The Li content a, and Na content b in the structure LiₐNa_{b}CoO₂ (a, b are different than x, y in equilibrium Li and Na phases) after reaching equilibrium can be calculated by a=x×f and b=y×(1−f). During evolution, Na components y (y=0.64, 0.565, and 0.50 at plateau I, II, and IV, respectively) are determined via coulomb counting by comparing the plateau voltages of OCV curves and that of the galvanostatic curve (FIG. 1A).

### Structural Selectivity

The structural selectivity is calculated based on the final composition LiₐNa_{b}CoO₂ versus the Li—Na ratio in the system as (a/b)/ratio.

### The Calculation of the Excess Amount of Li

The Li amount provided in 30 mL 1-1000 Li—Na ACN solution was 0.03 mmol. The exchanged Li amount in the 3 mg electrode with a final composition of Li_{0.90}Na_{0.02}CoO₂ was 0.0254 mmol. The excess amount of Li was calculated as 18%.

### X-Ray Diffraction

Synchrotron XRD measurements (0.1173 A) were conducted at the 13-BM beamline of Advanced Photon Source. Intensities in FIG. 1C and FIG. 2B have been normalized to make the strongest diffraction peaks have the same intensity. X-ray diffractions of P2-Na₂CoO₂, converted Li_{0.90}Na_{0.02}CoO₂, and converted Na_{y}CoO₂ were collected by using Rigaku MiniFlex 600 with a Cu Kα source. The Rietveld refinements were carried out using GSAS II. The instrument parameters were modified based on the “defaults for APS 30 KeV 11 BM”. Diffractions of single-phase Na_{0.57}CoO₂ and Na_{0.67}CoO₂ were first refined based on literatures. (Viciu, L. et al., 2006; Ono, Y. et al. Journal of Solid State Chemistry 166, 177-181 (2002).) The unit cell and atom coordination were refined. The obtained phase information as the reference was used for refining biphasic diffractions. Phase fraction was added for the biphasic diffraction refinement.

### Scanning Transmission Electron Microscopy (STEM)

The top-view of equilibrium particles showing Li—Na phase separation and atomic-resolution images of the fully converted Li_{0.90}Na_{0.02}CoO₂ were conducted by using the aberration-corrected scanning transmission electron microscope (STEM) JEOL ARM200CF at the University of Illinois at Chicago. The HAADF detector angle was 90-270 mrad to give Z contrast images. The low-angle annular dark-field detector angle ranged between 40 and 120 mrad. The energy dispersion for EELS (Gatan) was 0.15 eV/pixel with 0.1 s per pixel dwell time. EDS spectra imaging was acquired using an Oxford X-Max 100TLE windowless SDD detector. The cross-section views of the fully converted Na_{0.48}CoO₂ were conducted using the aberration-corrected scanning transmission electron microscope (STEM) JEOL ARM200CF at Northwestern University. EDS spectra imaging was acquired using a Dual SDD EDS detector.

Particles were removed from the electrodes after reaching the equilibrium by sonication and were drop-cast onto lacey carbon membrane-coated gold grids for top-view imaging. For the cross-section view imaging of the converted Li_{0.90}Na_{0.02}CoO₂, after removing from the electrodes, particles were embedded into Poly/Bed 812 resin and cut into 90 nm thick slides using a ultramicrotome (Ultracut E, Reichert-Jung). For the cross-section view imaging of the converted Na_{0.48}CoO₂, micron-sized particles were removed from the electrodes, which were site-specifically cut and thinned using conventional focused ion beam scanning electron microscopy (FIB-SEM, FEI Helios NanoLab 600). Specifically, a˜150 nm thick carbon layer and ˜1.2 m thick platinum layer were initially deposited using a gas injection system (GIS) to protect the surface of the target particle. After removal of an approximately 8×2×4 μm section via in-situ lift-out using a W micromanipulator (Oxford Omniprobe 200), the lamella was thinned at initially 30 kV, 0.49 nA, and subsequently at 5 kV, 81 pA. Finally, the sample was cleaned at 2 kV and 28 pA to yield a˜90 nm thick lamella.

### Scanning Electron Microscopy (SEM)

Scanning electron micrographs were obtained on a Zeiss Merlin scanning electron microscope using a 20 kV accelerating voltage. EDS spectra imaging was acquired using an Oxford Ultim Max 100 EDS detector.

### Inductively Coupled Plasma Mass Spectrometry (ICP-MS)

3% HNO₃ (aq) was used as the diluting matrix, and all the measurements used either Thermo iCAP Q ICP-MS or Thermo iCAP RQ ICP-MS.

Before dissolving, each electrode was washed at least 6 times with 10 mL ACN solution each time to remove residual salts on the surface as completely as possible. 8 mL aqua regia was used to dissolve each electrode.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” can mean only one or can be mean “one or more.” Embodiments of the inventions consistent with either construction are covered.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An electrode comprising an alkali transition metal oxide material comprising discrete Li_{0.94}MO₂ and Na_{y}MO₂ phases, where 0.45≤y≤0.51 and M is Co, Mn, or Ni, wherein the phase fraction of Li_{0.94}MO₂ in the alkali transition metal oxide material is at least 90 mol. %.

2. The electrode of claim 1, wherein M is the Co.

3. The electrode of claim 1, wherein M is the Mn.

4. The electrode of claim 1, wherein M is the Ni.

5. The electrode of claim 1, wherein the phase fraction of the Li_{0.94}MO₂ in the alkali transition metal oxide material is at least 95 mol. %.

6. The electrode of claim 1, wherein the phase fraction of Li_{0.94}MO₂ in the alkali transition metal oxide material is at least 98 mol. %.

7. The electrode of claim 1, wherein the alkali transition metal oxide material is disposed on an electrically conductive substrate or mixed with an electrically conductive powder.

8. The electrode of claim 2, wherein the alkali transition metal oxide material is disposed on an electrically conductive substrate or mixed with an electrically conductive powder.

9. The electrode of claim 8, wherein the phase fraction of the Li_{0.94}CoO₂ in the alkali transition metal oxide material is at least 95 mol. %.

10. The electrode of claim 8, wherein the phase fraction of the Li_{0.94}CoO₂ in the alkali transition metal oxide material is at least 98 mol. %.

11. An electrode comprising an alkali transition metal oxide material comprising Na_{y}MO₂ phases, where 0.45<y<0.51 and M is Co, Mn, or Ni, wherein the phase fraction of Na_{y}MO₂ in the alkali transition metal oxide material is at least 0.98 mol. %.

12. The electrode of claim 11, wherein M is the Co.

13. The electrode of claim 11, wherein M is the Mn.

14. The electrode of claim 11, wherein M is the Ni.

15. The electrode of claim 11, wherein the alkali transition metal oxide material consists of the Na_{y}MO₂ phases.

16. The electrode of claim 11, wherein the balance of the alkali transition metal oxide material comprises Li_{0.4}MO₂.

17. The electrode of claim 11, wherein the alkali transition metal oxide material is disposed on an electrically conductive substrate or mixed with an electrically conductive powder.

18. The electrode of claim 12, wherein the alkali transition metal oxide material is disposed on an electrically conductive substrate or mixed with an electrically conductive powder.

19. The electrode of claim 18, wherein the alkali transition metal oxide material consists of the Na_{y}CoO₂ phases.

20. A metal-ion battery comprising:
a battery compartment;
a cathode comprising an alkali transition metal oxide material comprising either:
discrete Li_{0.94}MO₂ and Na_{y}MO₂ phases, where 0.45<y<0.51 and M is Co, Mn, or Ni, wherein the phase fraction of the Li_{0.94}MO₂ in the material is at least 90 mol. %; or
a Na_{y}MO₂ phase, where 0.45<y<0.51 and M is Co, Mn, or Ni, wherein the phase fraction of the Na_{y}MO₂ in the material is at least 0.98 mol. %;
an anode in electrical communication with the cathode; and
a lithium ion-conductive electrolyte or a sodium ion-conductive electrolyte disposed between the anode and the cathode in the battery compartment.
